(19) United States
(12) Patent Application Publication
(10) Pub. No.: US 2025/0325973 A1
(43) Pub. Date: Oct. 23, 2025

(54) DEVICE MAKING POSSIBLE THE REGENERATION OF A HYDROCONVERSION CATALYST AND ASSOCIATED PROCESSES

(71) Applicant: AXENS, Rueil-Malmaison Cedex (FR)

(72) Inventors: Thierry GAUTHIER, Rueil-Malmaison Cedex (FR); Maxime CAILLOT, Rueil-Malmaison (FR); Fabian LAMBERT, Rueil-Malmaison (FR); Jean-François LE COZ, Rueil-Malmaison (FR); Delphine LE BARS, Rueil-Malmaison (FR)

(73) Assignee: AXENS, Rueil-Malmaison Cedex (FR)

(21) Appl. No.: 18/866,383

(22) PCT Filed: May 16, 2023
(86) PCT No.: PCT/EP2023/063134

§ 371 Date: Nov. 15, 2024

(30) Foreign Application Priority Data
May 18, 2022 (FR) FR2204729

(51) Int. Cl. B01J 38/12; B01J 8/26; C10G 47/30

(52) U.S. Cl. CPC B01J 38/12; B01J 8/26; C10G 47/30; B01J 2208/00769; B01J 2208/00991; C10G 2300/703

(57) ABSTRACT

The present invention relates to a process for the in situ regeneration of a hydroconversion catalyst. The invention also relates to a hydroconversion process comprising said regeneration process. The invention also relates to a system comprising a reaction section (40) comprising a hydroconversion reactor operating as an ebullating bed or as a moving bed; a regeneration section comprising a regeneration device (100); means for transfer of the hydroconversion catalyst between said reaction section (40) and said regeneration section comprising at least one fluidic connection; means for charging said regeneration device (100) as a fluidized bed or as a moving bed.

### FIELD OF THE INVENTION

The present invention relates to a process for the in situ regeneration of a hydroconversion catalyst. The invention also relates to a hydroconversion process comprising said regeneration process. The invention also relates to a system comprising a reaction section comprising a hydroconversion reactor operating as an ebullating bed or as a moving bed; a regeneration section comprising a regeneration device; means for transfer of the hydroconversion catalyst between said reaction section and said regeneration section comprising at least one fluidic connection; means for charging said regeneration device as a fluidized bed or as a moving bed.

The hydroconversion of residues is a process targeted at converting heavy feedstocks by exposing them to severe temperature conditions above 350° C., typically between 380° C. and 450° C., in the presence of hydrogen at high pressure, typically between 50 and 250 bar, in the presence of a solid catalyst containing metals, such as nickel or molybdenum, which are deposited on a support phase, often composed essentially of low acid alumina and with a porosity carefully designed to make possible the circulation of the reactants and to promote the deposition of coke and of metals while limiting the deactivation.

Under the hydroconversion temperature and pressure conditions, the feedstocks will tend to form coke on the catalyst. A significant part of the sulfur and nitrogen present in the feedstock is also deposited on the catalyst. The coke thus formed typically represents from 5% to 50% by weight of the initial weight of catalyst, depending on the operating conditions imposed, on the feedstock and on the catalyst. The content of coke deposited on the catalyst varies as a function of the residence time of the catalyst in the reactor. The longer the residence time, the greater the content of coke deposited on the catalyst.

Conventionally, when the hydroconversion process is carried out in an ebullating bed, a stage/a device for addition of fresh catalyst and removal of spent catalyst makes it possible to compensate for the deactivation of the catalyst by regularly carrying out removals and additional contributions of fresh catalysts.

Catalyst regeneration technologies exist for refining processes, such as, for example, reforming, which is used to upgrade a fraction of petroleum (heavy naphtha) to give gasoline; a regenerative reforming process is known employing a catalyst circulating as a moving bed in several reforming reactors coupled to a regenerator. FCC or “fluid catalytic cracking”, which is a process for the conversion of heavy feedstocks, such as atmospheric residues, employing a catalyst circulating as a fluidized bed, also comprises a regenerative technology.

There currently exists no process which makes it possible to regenerate a spent hydroconversion catalyst in situ, said spent catalyst being generally removed or then regenerated ex situ, which requires transportation, generally by truck, between the hydroconversion site and the regeneration site.

The patent U.S. Pat. No. 4,621,069 describes a process in which a catalyst deactivated by the deposition of coke and sulfur compounds is continuously regenerated ex situ by the staged combustion of the coke and the sulfur at controlled temperature in the presence of a gas stream containing a dilute concentration of oxygen. The catalyst is arranged in thin beds in an item of equipment having multiple treatment zones.

The patent EP 0 378 482 describes a process and the device for the regeneration of the catalyst of a reforming process, comprising at least two reactors. The catalyst comprises a support and at least one noble metal of the platinum family and chlorine. In the regeneration process, the spent catalyst travels progressively from the top downward in a regeneration chamber where it successively encounters: two moving bed zones where combustion takes place radially, then an oxychlorination moving bed zone and a calcination zone. The patent FR 2 837 113 discloses in more detail the regeneration device used in the process of EP 0 378482. The patent EP 0 200 474 also discloses the process for the regeneration of a reforming catalyst and also the configuration of the regeneration device.

The patent EP 0 332 536 discloses a process for the continuous regeneration of a catalyst, by combustion in a fluidized bed of the coke deposited on said catalyst during a hydrocarbon conversion reaction; this document discloses more particularly the regenerative technology of the FCC reactor. The FCC reactor connected to its regenerator operates under conditions where the phases present are gas and solid (catalyst), the feedstock to be converted is introduced in the liquid form but it is vaporized instantaneously in the gas form; the reactor thus operates under two-phase (gas-solid) conditions. In the FCC, the catalyst is fluidized, that is to say in suspension in the gas phase.

The present invention overcomes the deficiencies of the prior art with the development by the applicant company of a process which makes possible the regeneration of a hydroconversion catalyst in situ without leaving the hydroconversion plant. The regeneration process according to the invention also makes it possible to improve the quality of the regeneration in an optimal way by controlling the distribution of the stream of the regeneration gases over the entire bed of catalyst grains. The stages of charging and discharging the regeneration section are well controlled using moving bed or fluidized bed flow technologies.

The regeneration process and the system according to the invention comprise a regeneration device which makes it possible to regenerate the catalyst radially as is done by the regenerators used in regenerative reforming processes. This regeneration device differs from the devices of the prior art in that:
it can be configured so that the catalyst is capable of being returned to the reaction section after a combustion stage; thus, the regenerator is devoid of a second combustion zone and/or of an oxychlorination zone and/or of a calcination zone and/or a reduction zone;
it can be configured so that the catalyst can be transferred as a moving bed (by gravity) or as a fluidized bed, a fluidization liquid being introduced into the device together with the addition of spent catalyst. The moving bed configuration makes it possible to charge the catalyst very simply and rapidly to the regenerator, in particular when the catalyst grains are of spherical shape. The fluidized bed configuration makes possible protection of the catalyst grains which are charged to the regeneration device of the invention, in particular when they have complex shapes (multilobal, for example). The fluidization also makes it possible to homogenize the catalyst grains which, after settling out and drainage of the fluidization liquid, form a bed of catalyst grains which is homogeneous and better distributed within the device. The regeneration of the catalyst bed can then be carried out optimally.

The process for the in situ regeneration of a spent hydroconversion catalyst according to the invention has the advantage of being able to be operated continuously, the additions and withdrawal of catalyst being carried out during the operation of the hydroconversion reactor(s) without it being necessary to stop the process. As the regeneration process is incorporated in the overall hydroconversion process, this makes it possible to regenerate the hydroconversion catalyst in situ according to the requirements of the process. This also makes it possible for the operator to operate a unique process in which they can manage the addition/withdrawal of regenerated catalyst according to the nature of the treated feedstocks and according to the addition of fresh catalyst and the withdrawal of spent catalyst. The regeneration process according to the invention thus makes it possible to reduce the consumption of fresh catalyst.

### BRIEF DESCRIPTION OF THE FIGURES

FIG. 1 illustrates the implementation of the hydroconversion process of the invention according to one embodiment. Only the main lines and items of equipment relating to the use of the catalyst and its regeneration are represented in this figure.

FIG. 2 describes a regeneration device according to the invention making it possible to carry out regeneration of the catalyst by flow of the gas radially.

FIG. 3 describes a particular embodiment of the bottom of the regeneration device according to the invention with a porous lower wall 111 of the second chamber which is inclined, making possible better evacuation of the regenerated catalyst.

### DETAILED DESCRIPTION OF THE INVENTION

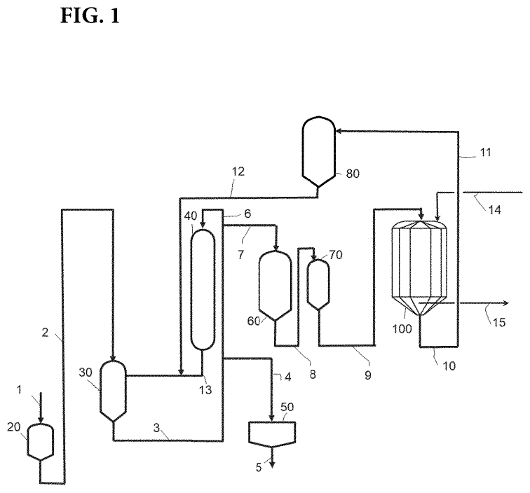

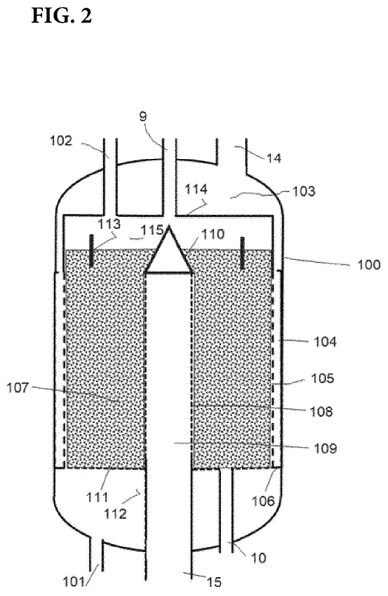

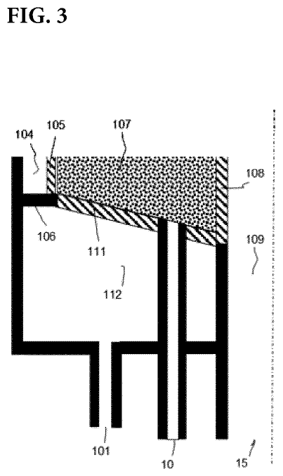

The process is described with reference to FIGS. 1, 2 and 3.

In the present description of the invention, the terms “catalyst”, “hydroconversion catalyst” and “catalyst grains” are interchangeable.

Throughout the present text, the terms “feeding” or “inlet” and “outlet” or “evacuation” and “to” or “in” or “into” or “out of” are used with reference to the direction of flow of the fluids.

### Regeneration Process

The present invention relates to a process for the in situ regeneration of a spent hydroconversion catalyst comprising the following stages:
a) transfer of the spent hydroconversion catalyst between a reaction section 40 comprising a hydroconversion reactor operating as an ebullating bed or as a moving bed, preferably operating as an ebullating bed, and a regeneration section comprising a regeneration device 100;
b) charging of the regeneration device 100 with the spent hydroconversion catalyst;
c) regeneration of the spent hydroconversion catalyst within the regeneration device 100 and the obtaining of a regenerated hydroconversion catalyst;
d) discharging of the regenerated hydroconversion catalyst from the regeneration device 100;
e) transfer of the regenerated hydroconversion catalyst between the regeneration section and the reaction section 40;
said reaction section 40 and said regeneration section being connected to each other by at least one fluidic connection making possible the transfers of the spent hydroconversion catalyst and of the regenerated hydroconversion catalyst.

The term “fluidic connection” is understood to mean a conduit, a circuit and/or optionally a vessel via which the hydroconversion catalyst is transported from a source to a destination by means of a liquid or of air.

The catalyst used in hydrocarbon residue hydroconversion processes is deactivated by the combined effect of the deposition of coke and of metals. It may then be advisable to withdraw catalyst from the reaction zone 40, to send it to a regeneration zone 100 dedicated to the controlled combustion of coke and of sulfur, and then, once the regeneration has been carried out, to return it to the reaction zone 40.

The regeneration process according to the invention is particularly suitable for a process for the hydroconversion of a hydrocarbon feedstock lightly charged with metals. The term “lightly charged with metals” is understood to mean a metal content of between 5 ppm by weight and 150 ppm by weight, more preferentially still between 10 and 75 ppm by weight. For these feedstocks, the coke content deposited on the catalyst increases faster than the metal content deposited, hence the advantage of the regeneration process according to the invention.

The metal content is, for example, evaluated according to the ASTM D8252 method, which indicates the content of nickel and vanadium “(Ni+V)” in ppm by weight.

The regeneration process according to the invention can be a catalyst regeneration process which is continuous or operated sequentially. Catalyst transfers between the reaction section and the regeneration section take place regularly during the operation of the hydroconversion process without halting the latter. In its operating mode, the regeneration device for its part preferably operates sequentially. The phases of combustion of the coke are preceded or followed by stages of charging, discharging, drying and inerting the catalyst and optionally by settling-out stages, when the transfer takes place as a fluidized bed. All these stages are preferably carried out within the regeneration device 100.

### Stage a) of Transfer Between the Reaction Section and the Regeneration Section

According to the invention, the regeneration process comprises a stage a) of transfer of the spent hydroconversion catalyst between a reaction section 40 comprising a hydroconversion reactor operating as an ebullating bed or as a moving bed, preferably as an ebullating bed, and a regeneration section comprising a regeneration device 100.

The reaction section 40 of stage a) can advantageously comprise one or more reactors in which a hydroconversion reaction takes place in the presence of a catalyst from the moment that an operation for withdrawal of a or any part of the catalyst can be carried out, for example a hydroconversion reactor operating as an ebullating bed (preferred mode) and also optionally as a moving bed.

Hydroconversion reactors are reactors operating under three-phase (gas-liquid-solid) conditions; they generally operate at high pressure to promote hydrogenation and the treated feedstocks are in the liquid state. The liquid phase is thus essentially the hydrocarbon fraction, the gas phase is hydrogen and also the converted light gas fractions, and the solid phase is the catalyst. The gas phase is a minor component and flows in the liquid phase.

In the hydroconversion reactor operating as an ebullating bed (also called a three-phase fluidized bed), the gas and the liquid flow axially in an upward movement. The velocity of the liquid is greater than the minimum fluidization velocity of the catalyst (which also depends on the gas flow rate). The catalyst is free to do as it likes in the reactor and moves inside a dense phase consisting of the liquid and the gas. The catalyst is introduced at one point and withdrawn at another point of the dense phase.

Examples of hydroconversion reactors operating as an ebullating bed are H-OIL® from Axens or LC Fining® from Lummus.

In the hydroconversion reactor operating as a moving bed, the catalyst is introduced in the top part of the reactor and flows axially from the top of the reactor downward under the effect of gravity grain by grain. The liquids and the gases flow either axially from the top downward or from the bottom upward in the reactor.

An example of hydroconversion reactor operating as a moving bed is the Hycon® reactor from Shell.

The regeneration section 100 can comprise one or more regeneration devices according to the invention.

In one embodiment, the regeneration process according to the invention is characterized in that the hydroconversion reaction section 40 comprises at least one, two or three hydroconversion reactors operating as an ebullating bed.

In one embodiment, the transfer of the spent hydroconversion catalyst between the reaction section 40 and the regeneration section is carried out by conveying in the liquid phase.

When conveying is carried out in the liquid phase, a person skilled in the art knows how to determine the nature and the flow rate of liquid necessary to achieve sufficient fluidization of the catalyst and to make possible its transportation from one vessel to another. It is well known to a person skilled in the art to implement a gentle fluidization in order to avoid impacts between the catalyst grains by observing a fluid velocity which is higher but close to the minimum fluidization velocity of the catalyst.

### Stage b) of Charging the Regeneration Device

According to the invention, the regeneration process comprises a stage b) of charging the regeneration device 100 with the spent hydroconversion catalyst.

In one embodiment, the regeneration section comprises a charging pot 70 containing the spent hydroconversion catalyst awaiting regeneration, and the stage of charging the regeneration device 100 with the spent hydroconversion catalyst comprises a stage of transfer of said spent hydroconversion catalyst between said charging pot 70 and said regeneration device 100. In this embodiment, the opening 9 of the regeneration device 100 making possible the entry of the spent catalyst into said device is in fluidic connection with a charging pot 70 by means of a substantially vertical conduit, preferably having a deviation with respect to the vertical of less than 25° to make possible gravity flowing between these two vessels. An isolation valve is preferentially positioned on this conduit. Preferably, the opening making possible the entry of the spent catalyst is positioned at the center of the regeneration device.

In one embodiment, the charging pot 70 is equipped with a device making it possible to measure the amount of spent hydroconversion catalyst present therein. For example, the measurement can be carried out with devices combining pressure measurements, using acoustic waves or radioactive rays.

The charging of the catalyst to the regeneration device can be carried out as a moving bed or preferentially as a fluidized bed.

In one embodiment, the stage of charging the regeneration device 100 with the spent hydroconversion catalyst is carried out as a fluidized bed. In this embodiment, a fluid, preferentially a liquid, passes through the regeneration device with a substantially vertical upward movement to make it possible to fluidize the catalyst to be regenerated in the regeneration device. The catalyst preferably flows by gravity and arrives in said fluid. The fluidization makes it possible to improve the distribution of the catalyst.

In a preferred embodiment, the stage of charging the regeneration device 100 with the spent hydroconversion catalyst is carried out as a fluidized bed with a fluidization liquid.

When the charging of the device is carried out as a fluidized bed, the catalyst present in the charging pot 70 is preferably also fluidized and flows into the regeneration device with a part of the fluidization liquid, the other part of the fluidization liquid being always introduced through the bottom of the regeneration device in an upward movement.

In one embodiment, when the charging of the regeneration device 100 with the spent hydroconversion catalyst is carried out as a fluidized bed, the regeneration process additionally comprises a stage of draining the fluidization liquid and a stage of drying the spent hydroconversion catalyst prior to the stage of regeneration of said spent hydroconversion catalyst. It is the same when the transfer between the reaction section 40 and the regeneration section is carried out by conveying in the liquid phase and when the device 100 is charged as a moving bed.

When the charging of the regeneration device is carried out as a fluidized bed, a liquid is introduced through the opening 101 of the first chamber of the regeneration device 100 and distributed in the second chamber 107 by virtue of its porous lower wall 111. The upward velocity of the liquid in the annular passage section of the second chamber 107 around the conduit 109 is greater than the minimum fluidization velocity of the catalyst. The liquid introduced via the opening 101 and the liquid introduced with the catalyst via the opening 9 leave the regeneration device 100 via the opening 102. During this phase, the other openings of the regeneration device are kept closed. Once the desired amount of catalyst has been introduced into the device, the feeding with liquid via the openings 101 and 9 is interrupted.

The term “minimum fluidization velocity” is understood to mean the minimum velocity at which the fluid has to pass through the bed of catalyst grains in order to make possible the suspension of the grains within this fluid. Under these conditions, the pressure drop of the fluid passing through the bed of catalyst grains corresponds to the weight of the bed.

This mode of charging as a fluidized bed is particularly suitable for processes using catalyst grains of complex (substantially nonspherical) shape, such as extrudates or multilobal catalysts, the granular flow characteristics of which are more problematic and limited because of their shape. This mode of operation makes it possible to limit the mechanical degradation of the catalyst by attrition. By fluidizing the catalyst grains under mild conditions (the fluidization velocity being close to the minimum fluidization velocity), any risk of blockage of the flow is avoided. Moreover, at the end of the charging, during the settling out of the bed of catalyst grains by halting of the fluidization, a homogeneous charging density throughout the device is obtained and also a uniform level of catalyst. The use of a liquid also makes it possible to have a homogeneous expansion of the bed without bubbles, which makes it possible to limit the attrition of the catalyst grains.

Preferentially, during the fluidization, the superficial velocity of the fluid in the bed of catalyst grains is from 2 to 5 times the minimum fluidization velocity of the catalyst particles.

Preferentially, the fluid used to fluidize the catalyst bed is a light petroleum cut sufficiently viscous to promote the fluidization of the catalyst. Preferentially, said fluid is chosen from a cut with a boiling range of between 150° C. and 380° C., for example a cut of hydrocarbons of kerosene and/or gas oil type.

Once the desired amount of catalyst grains has been introduced into the regeneration device 100 (for example when the charging pot 70 is empty), the feeding with fluidization liquid is interrupted. The catalyst grains then settle out naturally. The settling out makes it possible to naturally obtain a distribution of the catalyst grains forming a homogeneous bed having a substantially horizontal and uniform level over the entire section of the second chamber 107.

In one embodiment, the second chamber of the regeneration device comprises an empty space 115 located above the bed of catalyst grains when it is charged with settled-out grains of catalyst. This space is intended for the stages of transfer of the catalyst as a fluidized bed. This is because, when the bed of catalyst grains will be fluidized during the discharging, it will undergo an expansion in volume which has to be contained in the volume of the second chamber 107 in order to avoid any overflowing of the bed via one of the openings 102 or 9 while making it possible for the fluidization to be optimal.

Preferably, the volume of the empty space 115 makes it possible to absorb an expansion in volume of between 10% and 100% of the volume of the bed of catalyst grains after charging and settling out, preferentially of between 25% and 50% of this volume.

Once the catalyst grains have settled out, the fluidization liquid has to be evacuated by draining all of the parts constituting the regeneration device. All the openings 102, 9, 101 and 10, 14 and 15 of the device can make possible the draining of the fluidization liquid.

Once the draining stage has been carried out, a stage of drying the catalyst has to be carried out. During the drying stage, an inert drying gas, such as nitrogen, is introduced into the regeneration device via the openings 14, 9 or 102 and then comes out via the central conduit 109, the other openings being closed. This inert gas is advantageously heated upstream of the regeneration device 100 to a temperature of between 250° C. and 400° C. according to the liquid used during the charging in order to make possible its evaporation. The drying gas containing the evaporated hydrocarbons is subsequently advantageously cooled, in order to condense the hydrocarbons, and then is advantageously reheated and recompressed in order to be subsequently reintroduced into the regeneration device.

The draining and drying stages make it possible to minimize the amounts of coke present on the spent catalyst grains, which will subsequently be incinerated during the phase of regeneration by combustion.

On conclusion of the drying stage, the catalyst can be regenerated.

In one embodiment, the stage of charging the regeneration device 100 with the spent hydroconversion catalyst is carried out as a moving bed. In this embodiment, the catalyst is not fluidized during the catalyst charging but it is charged by gravity flowing to said regeneration device; in this case, the catalyst introduced via the opening 9 flows by gravity into the second chamber 107 of the device. This embodiment is ideally implemented when the hydroconversion catalysts are of spherical shape. Transfers as a moving bed are well known to a person skilled in the art for spherical catalysts. It is a matter of transferring by gravity between the items of equipment when this is possible. When transfer by gravity is not possible, if the arrival vessel is located higher, a person skilled in the art can employ a stream of inert gas to cause the catalyst to rise. The gas stream is then divided into two conduits: the first making it possible to fluidize an amount of catalyst to be fluidized in a dedicated vessel. The second stream subsequently makes it possible to set in motion the amount of catalyst in a pipe heading for the arrival vessel. The catalyst then flows without the surrounding medium being fluidized.

When transfer as a moving bed is employed, the settling out, draining and drying stages are not necessary. Moreover, it is pointless to provide an empty space 115 located above the bed of catalyst grains.

### Stage c) of Regeneration of the Spent Catalyst

According to the invention, the regeneration process comprises a stage c) of regeneration of the spent hydroconversion catalyst within the regeneration device 100 and the obtaining of a regenerated hydroconversion catalyst.

In one embodiment, the regeneration comprises a stage of combustion of the coke and of the sulfur compounds of the spent hydroconversion catalyst, carried out with a gas stream comprising oxygen passing radially through said spent hydroconversion catalyst within the regeneration device 100.

In one embodiment, the regenerated hydroconversion catalyst is preferably devoid of the majority of the coke which it initially contained, preferably devoid of 80% by weight of the amount of coke initially contained, more preferably 90%, indeed even 100%, of the amount initially contained, and can subsequently be reused according to the requirements of the operation of the hydroconversion reaction zone.

Preferably, once the spent catalyst has been charged to the regeneration device 100, the level of the spent catalyst has to be greater than the highest part of the porous section of the side walls 105 and 108 of the second chamber of the device. Thus, the height of the bed of catalyst grains located above the porous section of the second chamber 107 will provide resistance to the flow of the gases above the catalyst bed during the drying, purging or regeneration phases. This is because the gases flowing radially might bypass the bed of catalyst grains by flowing in the space left free above the bed and detrimentally affect the performance qualities of the system.

The stage of regeneration of the spent catalyst is carried out by movement of the combustion gases radially in the catalyst bed, in a direction which is substantially horizontal and preferentially directed from the outside to the inside of the regeneration device 100. This makes it possible to optimize the favorable distribution of the oxidizer in the regenerator and thus to have good uniform contact between the oxidizer (combustion gas) and the fuel (coke present on the spent catalyst grains) during the regeneration and to avoid hot spots and preferential passages which would induce poor regeneration or hydrothermal degradation of the catalyst.

The term “radially” is understood to mean that the gases pass through the second chamber 107 of the regeneration device 100 via the porous parts of the side walls 105 perpendicularly to the vertical axis of the device; the gases thus pass through the catalyst bed perpendicularly to the vertical axis of the bed. In this arrangement, the catalyst forms a layer distributed around the central collector formed by the third chamber 109, in which the regeneration gases are distributed uniformly. In this device, the regeneration of the catalyst is thus of good quality.

In one embodiment, the device is configured so that a first part of the regeneration gases, preferably the majority of the regeneration gases, or at least 70%, preferentially at least 80%, of the regeneration gases, passes radially through the bed of catalyst grains. This part of the gases is advantageously introduced via the opening 14 into the first chamber of the regeneration device 100 which spreads through the first empty upper zone 103, 104 of said device.

In this implementation, preferably, the remaining part of the gases which are not introduced into the device via the opening 14 enters the second chamber 107 via the top, for example through the opening 9, or via the base of the bed of catalyst grains, for example via the opening 101, where the gas spreads through the second empty lower zone 112 located between the first and the second chambers and passes through the porous lower wall 111 of the second chamber and mixes with the regeneration gases predominantly introduced via the opening 14.

In one embodiment, the empty lower zone 112 is preferentially at a slight excess pressure with respect to the lower zone of the bed of catalyst grains which is contained in the second chamber 107. This is achieved, for example, by injecting small amounts of gas through the opening 101. By virtue of the pressure drop offered to the passage of this gas through the porous lower wall 111 of the second chamber, the empty space 112 is then under excess pressure with respect to the bed of catalyst grains, which limits the passage of gas from the bed of catalyst grains to the empty lower zone 112.

The fact of introducing said remaining part of the gases into the regeneration device 100 via the base or the top of the bed of catalyst grains makes it possible, on the one hand, to regenerate the catalyst grains located above the top of the porous parts of the side walls 105 and 108 and, on the other hand, to prevent gas passing through the bed radially to bypass it by moving in the empty space 115 located above the bed or in the empty lower zone 112 located below the porous lower wall 111 of the second chamber. This is because the regeneration gases have a tendency to flow through the zones offering the least flow resistance and thus offering a lower pressure drop. By reinforcing the flow resistance in the empty spaces 115 and 112, the radial flow of the regeneration gases passing through the bed of catalyst grains is thus optimized.

The presence of one or more plates 113 within the second chamber 107 of the regeneration device 100 makes it possible to increase the resistance to the flow of the gases in the empty space 115. Preferably, the top part of the plate or plates 113 emerges above the bed of catalyst grains into the empty space 115 of the second chamber 107.

Preferably, the radial velocity of the gases during the regeneration phase at the inlet of the catalyst bed at the periphery is between 0.02 and 0.5 m/s.

Preferably, the radial velocity under the same conditions but at the outlet of the catalyst bed will preferentially be between 0.25 and 2.5 m/s.

In one embodiment, the opening 14 for the admission of the regeneration gases within the regeneration device 100 is in fluidic connection with a gas circuit making it possible to recycle in part the gases entering said device. An isolation valve is preferentially positioned on this conduit. Preferably, this opening is also used, if necessary, for introduction into the device of gases making it possible to dry the bed of catalyst grains to be dried after charging and for purging the device.

In one embodiment, the opening 15 which makes possible the evacuation of the combustion flue gases resulting from the regeneration of the bed of catalyst grains and also of the gases resulting from the drying of the bed of catalyst grains after the loading and the purging of the regeneration device 100 is connected to the gas circuit making it possible to recycle in part the gases entering the reactor via the opening 14. An isolation valve is preferentially positioned on this conduit.

The stage of combustion of the coke and of the sulfur compounds is preferably carried out in a stage of controlled combustion in the presence of oxygen.

On the one hand, the combustion stage is carried out while limiting the concentration of oxygen available in the gas at the inlet of the regeneration device to a content of preferably between 0.1% and 5% by volume. This makes it possible to control the conditions under which the fuels deposited on the catalyst grains (coke, sulfur, nitrogen) are brought into contact with the oxidizer (oxygen contained in the regeneration gas) in order to avoid damage to the properties of the catalyst grains. This is because the catalyst grains are sensitive to the hydrothermal deactivation associated with the presence of steam at high temperatures.

In one embodiment, the combustion gas comprises a controlled content of oxygen, typically between 0.1% and 5%, preferentially between 0.3% and 1%.

On the other hand, the combustion stage is carried out while controlling the distribution of the gas so that the flow is as uniform as possible in contact with the catalyst grains.

In one embodiment, the combustion gas is preheated to a temperature of between 250° C. and 600° C., preferentially of between 275° C. and 500° C.

As the combustion stage is carried out while limiting the supply of oxygen, this makes it possible to control the progress of the combustion reactions and thus to limit the increase in the temperature. The temperature of the gas at the inlet of the regeneration device is thus gradually raised while limiting the temperature gradient in the combustion zone in order to limit the temperature at the outlet of the device below a value generally of between 350° C. and 600° C. according to the nature of the catalyst grains to be regenerated.

In one embodiment, the regeneration is carried out via increasing stationary phases of temperature, limiting the heating of the catalyst bed to a temperature gradient of between 10° C. and 100° C., preferably between 25° C. and 50° C.

When the outlet temperature values and the oxygen concentration values of the exiting combustion gas approach the values characterizing the gas at the inlet, it is possible to increase the temperature of the gas at the inlet. The combustion stage is typically terminated when heating or oxygen consumption is no longer observed at the maximum temperature of the inlet gases acceptable for the catalyst grains.

In one embodiment, a part of the regeneration flue gases exiting from the regeneration device 100 can be recycled at the inlet of the device after a scrubbing and/or purification stage in order to be freed at least in part from the sulfur and nitrogen oxides resulting from the combustion of the coke, for example by contact with an aqueous sodium hydroxide solution, and after a compression stage in order to compensate for the pressure drop.

In one embodiment, at least one or more charge-effluent exchangers make it possible to preheat the combustion gas with at least a part, indeed even all, of the combustion flue gases exiting at higher temperatures and optionally with external heat sources.

In one embodiment, before recycling the combustion flue gases after scrubbing or purification, an additional contribution of fresh air making possible the regeneration is provided, an additional contribution of inert gas making possible the drying or the inerting, preferentially nitrogen, is provided and also a purging of the flue gases is carried out and also a bypassing to an exchange system making it possible to condense the hydrocarbons possibly produced during the intermediate phases of drying the catalyst between the charging of the reactor with liquid phase and the regeneration which is carried out in the gas phase is carried out.

The time required for the regeneration is related to the amount and to the composition of the coke deposited on the catalyst and also to the oxygen concentration chosen to control the regeneration conditions and to limit the heating of the catalyst grains. Typically, it is possible to regenerate the catalyst grains by incinerating from 80% to 100% of the coke deposited on the grains in less than 96 hours, preferably between 48 h and 72 h, while limiting the temperature difference between the regeneration inlet and outlet below 50° C.

In one embodiment, the regeneration stage c) additionally comprises a stage of inerting the regenerated hydroconversion catalyst before the discharging from the regeneration device. This stage is carried out by movement of an inert gas, such as nitrogen, for example, through all the parts constituting the device.

In one embodiment, the bed of catalyst grains is cooled to a temperature of less than 300° C., preferentially of less than 100° C., before proceeding to the discharging of the grains.

Preferably, on conclusion of the regeneration stage c), the regenerated catalyst devoid of the majority of the coke deposited during the hydroconversion recovers most of its catalytic activity making it possible for it to desulfurize and to demetallize the hydroconverted hydrocarbons.

### Stage d) of Discharging the Regenerated Hydroconversion Catalyst

According to the invention, the regeneration process comprises a stage d) of discharging the regenerated hydroconversion catalyst from the regeneration device 100.

In one embodiment, the regeneration section additionally comprises a storage chamber 80 for the regenerated hydroconversion catalyst and the stage of discharging the regenerated hydroconversion catalyst from the regeneration device 100 comprises a stage of transfer of said regenerated hydroconversion catalyst between said regeneration device 100 and said storage chamber 80. In this embodiment, the at least one opening 10 of the regeneration device making possible the exit of the catalyst grains after regeneration is in fluidic connection at the one end with the inside of the second chamber 107 and at the other end with a storage chamber 80 for the regenerated hydroconversion catalyst. An isolation valve is preferentially positioned on this conduit. Preferably, the volume of the conduit located upstream of the isolation valve is minimized. Preferably, the fluidic connection is substantially vertical.

The discharging of the catalyst grains is carried out as a moving bed or as a fluidized bed, preferably as a fluidized bed.

In a preferred embodiment, the discharging of the catalyst from the regeneration device is carried out as a fluidized bed. In this embodiment, a fluid, preferentially a liquid, passes through the regeneration device 100 with a substantially vertical upward movement to make it possible to fluidize the regenerated catalyst in the regeneration device and to transport it through the at least one opening 10. The fluidization of the catalyst during the discharging from the regeneration device makes it possible to facilitate the flow and to prevent any catalyst blockage in the regeneration device. In this case, a liquid is introduced through the opening 101 of the regeneration device 100 and distributed in the second chamber 107 by virtue of the porous lower wall 111. The liquid passes through the bed of catalyst grains axially from the bottom of the device upward, which will make possible rapid discharging of the regenerated catalyst grains.

In one embodiment, the opening 102 of the regeneration device making it possible to evacuate the excess liquid used to fluidize the catalyst grains is in fluidic connection with a circuit making possible the evacuation of said fluid during the charging and discharging phases. An isolation valve is preferentially positioned on this conduit.

The opening 10 of the regeneration device makes possible the gravity flowing of the mixture comprising the catalyst grains and a part of the fluidization liquid, once the catalyst grains have been fluidized. During the fluidization and the discharging, the other openings of the regeneration device are closed.

When the lower wall 111 of the second chamber of the regeneration device is of conical shape pointing to the bottom of the device, the discharging of the catalyst is carried out more easily. The inclined lower part 111 facilitates the evacuation of the catalyst through the opening 10, including in the event of a problem linked to fluidization problems, such as a partial blockage of the lower wall 111.

In one embodiment, the catalyst grains fluidized during the discharging flow by gravity, with a possible upstream pressurization, into the opening 10 and are subsequently taken up by means making possible their transportation, optionally as far as the storage chamber 80, such as, for example, an injection of transportation liquid making possible the transportation in suspension in pipes proportioned for this purpose.

In one embodiment, an isolation valve is preferentially positioned on the conduit connected to the opening 101 making it possible to introduce the fluid making it possible to fluidize the catalyst grains during the charging of and/or the discharging from the regeneration device.

In one embodiment, the discharging of the catalyst from the regeneration device is carried out as a moving bed by gravity flowing of the catalyst through the at least one opening 10 of the regeneration device 100. In this case, the catalyst grains flow by gravity through the opening 10 without them being fluidized in the second chamber 107, or else a liquid can all the same be introduced with a lower velocity than the fluidization velocity of the catalyst grains, making it possible only to facilitate the natural flow of the catalyst grains via the conduit 101. This embodiment can be envisaged when the gravity flowing of the particles is easy, for example when the particles have a substantially spherical shape.

When the discharging is carried out as a moving bed, the opening 10 making possible the exit of the regenerated catalyst is positioned at the center of the regeneration device for the single opening or on a circular ring if there are several openings.

In this embodiment, the catalyst grains flow by gravity during the discharging, either to an intermediate holding chamber (not represented) or directly to the regenerated hydroconversion catalyst storage chamber 80. If necessary, they can be taken up by means making possible their transportation up to said storage chamber 80, such as, for example, an injection of transportation liquid making possible the transportation in suspension in pipes proportioned for this purpose.

### Stage e) of Transfer Between the Regeneration Section and the Reaction Section

According to the invention, the regeneration process comprises a stage e) of transfer of the regenerated hydroconversion catalyst between the regeneration section and the reaction section 40.

In one embodiment, the transfer of the regenerated hydroconversion catalyst between the regeneration section and the reaction section 40 is carried out by conveying in the liquid phase.

### Hydroconversion Process

The present invention also relates to a hydroconversion process comprising the following stages:
I. a stage of hydroconversion of a hydrocarbon feedstock having an initial boiling point of at least 300° C. carried out in a reaction section 40 comprising a reactor operating as an ebullating bed or as a moving bed in the presence of a hydroconversion catalyst and of hydrogen;
II. a stage of withdrawal of spent hydroconversion catalyst and of additional contribution of fresh hydroconversion catalyst originating from a storage chamber 20 for the fresh catalyst and/or of hydroconversion catalyst regenerated according to the regeneration process according to the invention within said reaction section 40.

### Hydroconversion Stage I.

The hydroconversion process according to the invention comprises a stage I. of hydroconversion of a hydrocarbon feedstock having an initial boiling point of at least 300° C. carried out in a reaction section 40 comprising a reactor operating as an ebullating bed or as a moving bed in the presence of a hydroconversion catalyst and of hydrogen.

In a preferred embodiment, the hydroconversion stage is carried out in one or more ebullating bed reactors, in particular two or three ebullating bed reactors. This type of reaction section makes it possible to properly control the temperatures within the reaction zone. The reaction zone of an ebullating bed process generally consists of one or more trains of reactors containing one or more reactors in series.

In one embodiment, the hydroconversion stage is carried out under an absolute pressure of between 2 and 35 MPa.

In one embodiment, the hydroconversion stage is carried out at a temperature of between 300° C. and 550° C.

In one embodiment, the hydroconversion stage is carried out at an hourly space velocity (or HSV) of between 0.05 h⁻¹ and 10 h⁻¹.

In one embodiment, the hydroconversion stage is carried out under an amount of hydrogen mixed with the feedstock of between 50 and 5000 standard cubic meters (Sm³) per cubic meter (m³) of liquid feedstock.

In one embodiment, the hydroconversion stage is carried out with a porous supported catalyst comprising an alumina support and at least one metal from group VIII chosen from nickel and cobalt, said element from group Vlll being used in combination with at least one metal from group VIB chosen from molybdenum and tungsten.

In ebullating bed hydroconversion processes, the catalyst is generally employed in the form of extrudates, the diameter of which generally varies between 0.5 and 3 mm, the length of the extrudate generally corresponding to a length ranging from 1.5 to 10 times the diameter of the grain. It is also possible to envisage shaping in the form of beads of similar diameter or of multilobal particles, the mean characteristic sizes of which are similar.

The feedstock of the hydroconversion process according to the invention preferably comprises “heavy” hydrocarbons having an initial boiling point of at least 300° C.

The feedstocks converted in this type of process are generally heavy feedstocks characterized by their boiling curve and are generally feedstocks, less than 5% of which distills under atmospheric conditions at a temperature of 340° C. The process is particularly suitable for the conversion of feedstocks containing at least 60% of feedstock distilling above 500° C. These feedstocks are characterized by high contents of sulfur, nitrogen and metals, which are largely removed during the hydroconversion reactions.

Typically, a feedstock highly charged with metals will contain of the order of 50 to 500 ppm, generally essentially nickel and vanadium, which, during the hydroconversion reactions, will be deposited on the catalyst, it being possible for the amounts of metals deposited to typically reach from 5% to 50% by weight of the initial weight of the catalyst. The regeneration process according to the invention is particularly suitable for a heavy hydrocarbon feedstock with a content of metals of between 5 ppm by weight and 150 ppm by weight, more preferentially still between 10 and 75 ppm by weight.

Said feedstock can be of petroleum origin of atmospheric residue or vacuum residue type resulting from “conventional” crude (API degree>20°), heavy crude (API degree between 10° and) 20° or extra-heavy crude (API degree<10°) or crude oil. It can originate from different geographical and geochemical (type I, II, IIS or III) sources, with degrees of maturity and biodegradations which are also different.

This feedstock can also be chosen from the following feedstocks: a residual fraction resulting from the direct liquefaction of coal (atmospheric residue or vacuum residue resulting, for example, from the H-Coal™ process), an H-Coal™ vacuum distillate, a residual fraction resulting from the direct liquefaction of lignocellulose biomass, which are alone or as a mixture. These feedstocks can be mixed with coal and/or a residual petroleum fraction.

This type of feedstock is generally rich in impurities with contents of metals of at least 5 ppm by weight, in particular of at least 10 ppm by weight, typically of the order of 10 to 500 ppm by weight of metals, essentially nickel and vanadium.

The sulfur content is typically at least 0.5%, in particular at least 1%, in particular greater than 2%, by weight. The content of C7 asphaltenes is in particular greater than 1%, in particular of between 1% and 40% and more preferably between 2% and 30%, by weight.

Stage II. of Withdrawal of the Spent Catalyst and of Additional Contribution of Fresh Catalyst and/or of Regenerated Catalyst.

The hydroconversion process according to the invention comprises a stage II. of withdrawal of spent hydroconversion catalyst and of additional contribution of fresh hydroconversion catalyst originating from a storage chamber 20 for the fresh catalyst and/or of hydroconversion catalyst regenerated according to the regeneration process according to the invention within said reaction section 40.

Said hydroconversion reactor(s) are provided with a system for additional contribution and for withdrawal of the catalyst.

The withdrawal of spent catalyst and the additional contribution of fresh catalyst on a regular basis makes it possible to have available a substantially constant catalyst quality in the reactor.

In one embodiment, it is possible to withdraw spent catalyst from one reactor and to supply regenerated catalyst to another reactor. In this case, the spent catalyst is typically withdrawn from the first reactor and the fresh and/or regenerated catalyst is added to the last, indeed even the penultimate, hydroconversion reactor.

Preferably, the spent catalyst can be withdrawn from each of the reactors or else from one or more of the reactors, in particular from the first reactor and/or optionally from the second reactor. According to the units, it is also possible to withdraw spent catalyst from one of the reactors and then to add it to another reactor.

In one embodiment, the regenerated catalyst can be added to each of the reactors or else to one or more of the reactors.

In one embodiment, the stages of withdrawal of spent hydroconversion catalyst and of additional contribution of fresh hydroconversion catalyst and/or of regenerated hydroconversion catalyst are carried out by a single device which can be pressurized and depressurized 30. In this embodiment, the single device is a catalyst charging and/or discharging pot, known as “high pressure” pot or HP pot 30 because it can operate at the pressure of the hydroconversion reactor(s), and has the possibility of being in fluidic connection with each of the reactors. This item of equipment makes possible the transfer of catalyst between the different items of equipment.

In one embodiment, the stages of withdrawal of spent hydroconversion catalyst and of additional contribution of fresh hydroconversion catalyst and/or of regenerated hydroconversion catalyst are carried out by conveying in the liquid phase. Preferably, the liquid used is a hydrocarbon which is sufficiently heavy not to significantly vaporize during the conveying. Typically, the liquid used is a cut with a boiling range of between 300° C. and 550° C., for example a cut of hydrocarbons of vacuum distillate type.

In one embodiment, the HP pot 30 carries out the conveying of hydroconversion catalyst in the liquid phase to the different units. The HP pot 30 is used both to add fresh catalyst or regenerated catalyst to the reactor and to withdraw catalyst from the reactor for the purpose of regenerating it or of removing it if it is excessively charged with metals.

The use of a single device making it possible to link together the different catalyst storage vessels and units makes it possible, to begin with, to considerably reduce the costs related to the process, such a device being expensive, but also makes it possible to simplify the process with a single conveying device well integrated into an overall hydroconversion process with in situ regeneration of catalyst.

In one embodiment, the HP pot 30 is equipped with a level measurement making it possible to measure the amounts, preferentially the volumes, of hydroconversion catalyst, added or withdrawn from the reaction zone.

In one embodiment, the HP pot 30 is in fluidic connection with a storage chamber 60 which contains the spent hydroconversion catalyst to be sent to regeneration.

In one embodiment, the HP pot 30 is in fluidic connection with a “low pressure” pot referred to as LP pot 50 which makes it possible to store the spent catalyst to be removed.

Typically, when catalyst is withdrawn from the reaction zone 40 in order to remove it or for the purpose of regenerating it, the spent catalyst is transferred from the reaction section to the HP pot 30, which is then pressurized. The HP pot 30 is then depressurized and the catalyst is transferred to the LP pot 50 or the storage chamber 60. The storage chamber 60 makes it possible to store a sufficient amount of catalyst making it possible to decouple the frequency and the duration of the regeneration cycles from the frequency and the amounts of catalyst withdrawn.

In one embodiment, the storage chamber 60 subsequently feeds a charging pot 70. The storage chamber 60, or more preferentially the charging pot 70, subsequently feeds the regeneration device 100.

In one embodiment, the storage chamber 60 is equipped with a device which makes it possible to measure the amounts of catalyst.

In one embodiment, the HP pot 30 is in fluidic connection with a storage chamber 80 which contains regenerated hydroconversion catalyst.

In one embodiment, the HP pot 30 is in fluidic connection with a “low pressure” pot referred to as LP pot 20 which contains fresh catalyst.

Typically, when fresh catalyst is added, the desired amount of fresh catalyst is transferred from the first LP pot 20 to the HP pot 30 at low pressure. Then, the pressure of the HP pot 30 is raised until a sufficient pressure for proceeding to the transfer of the catalyst from the HP pot 30 to the reaction zone 40 is reached.

In one embodiment, the HP pot 30 is remotely controlled by an operator.

In a preferred embodiment, the HP pot 30 is proportioned in order to proceed to the daily addition of the same required amount of fresh or regenerated catalyst, the operator choosing to add fresh catalyst or regenerated catalyst according to the content of metals of the feedstock.

The hydroconversion process according to the invention thus allows great flexibility to the operator who, with the regeneration process integrated into the system for addition and withdrawal of catalysts, can treat feedstocks with highly variable contents of metals while keeping substantially constant the content of coke and metals deposited on the catalyst in the hydroconversion reactors.

The process according to the invention also makes it possible to flexibly treat feedstocks of variable compositions, in particular with variable contents of metals, the operator having the possibility of replacing the catalyst withdrawn from the reaction zone 40 with fresh catalyst or regenerated catalyst according to their requirements. It is possible to keep substantially constant the content of coke and of metals deposited on the catalyst in the hydroconversion reactors. In other words, in the process according to the invention, the content of metals on the catalyst is decoupled from the content of coke, since the operator can control:
on the one hand, the additional contribution of fresh catalyst (containing neither metals nor coke),
and, on the other hand, the additional contribution of regenerated catalyst (not containing coke but metals originating from hydrocarbon feedstocks).

The processes according to the invention thus make it possible for the operator to limit the addition of fresh catalyst to feedstocks containing little in the way of metals while keeping controlled contents of coke deposited on the catalyst.

### System

The present invention also relates to a system comprising:
a reaction section 40 comprising a hydroconversion reactor operating as an ebullating bed or as a moving bed;
a regeneration section comprising a regeneration device 100;
means for the transfer of hydroconversion catalyst between said reaction section 40 and said regeneration section comprising at least one fluidic connection;
means for charging said regeneration device 100 as a fluidized bed or as a moving bed.

In one embodiment, the regeneration device of the system according to the invention comprises:
a first chamber 100 arranged around a vertical axis comprising, in its upper part, an opening for admission of regeneration gas 14 and an opening for entry of the spent catalyst 9, said first chamber 100 comprising, in its lower part, an opening for departure of the regeneration gases 15 and an opening for departure of the regenerated catalyst 10;
a second chamber 107, concentric with the first chamber 100 and arranged inside the latter so as to form a space between said first chamber 100 and said second chamber 107, said second chamber being capable of containing a bed of grains of spent catalyst to be regenerated and comprising a leaktight upper wall 114, side walls 105 which are porous over at least a part of their height, the porosity of said side walls 105 being suitable for making possible the flow of the regeneration gases, and a lower wall 111, said second chamber 107 being in fluidic connection with the opening for entry of the spent catalyst 9 and the opening for departure of the regenerated catalyst 10;
a third chamber forming a central conduit 109 concentric with the second chamber 107 passing through said second chamber 107 and the first chamber 100, said third chamber 109 being porous over all of the parts of its side walls 108 contained in said second chamber 107 for the evacuation of the regeneration gases, said third chamber 109 being in fluidic connection with the opening for departure of the regeneration gases 15.

The term “leaktight” is understood to mean which does not allow gases, liquids or solids to pass through.

The term “regeneration gas” is understood to mean drying, inerting and combustion gases.

The term “upper part of a chamber” is understood to mean the top of the first chamber, generally of hemispherical or elliptical type, and also the upper 15% of the shell.

The term “lower part of a chamber” is understood to mean the bottom of the vessel, generally of hemispherical or elliptical type, and also the lower 15% of the shell.

In one embodiment, the regeneration device of the system according to the invention is charged with hydroconversion catalyst within its second chamber 107.

In one embodiment, the regeneration device of the system according to the invention comprises a partition 106 arranged in the space between the first chamber 100 and the second chamber 107 supporting the side walls 105 of said second chamber 107 and separating in a leaktight manner said space between the first chamber 100 and the second chamber 107 into a first empty upper zone 103, 104 and a second empty lower zone 112, and the first chamber 100 comprises, in its lower part, an opening 101 for the introduction and the departure of a fluidization liquid in said second empty lower zone 112 and the lower wall 111 of the second chamber 107 is porous in order to make possible the flow of said fluidization liquid into said second chamber 107.

Typically, the partition 106 can be a generally flat support ring of a few centimeters in width which is welded in the lower part of the internal face of the first chamber 100 and on which the second chamber 107 will rest. It serves as support for the second chamber 107 and produces a leaktight separation of the space located between the first chamber 100 and the second chamber 107 into two distinct zones. A collar of conical shape can also be used.

The porous walls which make it possible to properly distribute the fluids (gases and liquids) can consist, by way of nonlimiting examples, of perforated plates, of grids assembled in lamellae, of sheets of sintered metal. Modular stacks of objects consisting of porous walls and forming, by assembling, a porous wall can also be envisaged.

The greatest size of the pores of the lower wall of the second chamber 111 is smaller than the diameter of the catalyst grains in order to properly confine the bed of catalyst grains. The size of the pores of the porous lower wall of the second chamber 111 makes it possible for the fluidization liquid to pass through.

The greatest size of the pores of the porous parts of the side walls of the second chamber 105 and of the side walls of the third chamber 108 is smaller than the diameter of the catalyst grains in order to properly confine the bed of catalyst grains. The size of the pores of the porous parts of the side walls of the second chamber 105 and of the 108 makes it possible for the regeneration gases to pass through.

The porous parts of the side walls of the second chamber 105, of the lower wall of the second chamber 111 and of the parts of the side walls 108 of the third chamber contained in said second chamber are advantageously proportioned in order to obtain good distribution of the fluids over the various passage sections of the regeneration device.

The pressure drop provided by these porous walls is sufficient to make it possible to distribute the fluids over the passage section.

The pressure drops on passage of the gases radially through the granular bed are preferably between 1 kPa and 100 kPa, preferably between 10 kPa and 50 kPa.

The pressure drop through the porous parts of the side walls of the second chamber 105 and of the parts of the side walls 108 of the third chamber contained in said second chamber is preferably between 1 kPa and 100 kPa, preferably between 10 kPa and 50 kPa.

The pressure drop through the porous lower wall 111 of the second chamber is preferably between 1 kPa and 100 kPa, preferably between 10 kPa and 50 kPa.

In order to promote the distribution of the fluidization liquid through the porous lower wall 111 of the second chamber, its unit pressure drop (under similar conditions and for a similar passage section) is preferentially at least equal to the unit pressure drop of the porous parts of the side walls of the second chamber 105 or of the parts of the side walls 108 of the third chamber contained in said second chamber.

The pressure drop of a porous wall is the difference in pressure between the two chambers which it separates; it depends on the flow rate treated and on the porosity of the walls.

In one embodiment, the first chamber 100 of the regeneration device of the system according to the invention comprises, in its upper part, an opening 102 for the evacuation of the excess fluidization liquid, said opening 102 being in fluidic connection with the second chamber 107.

In one embodiment, the regeneration device of the system according to the invention comprises a deflector 110 installed in the second chamber 107 above the third chamber 109 and below the opening for entry of the spent catalyst 9.

In one embodiment, the regeneration device of the system according to the invention comprises several openings for entry of the catalyst 9. They can be positioned centrally and/or peripherally in the upper part of the first chamber 100. This alternative form can be employed when the regeneration device is large in size.

In one embodiment, the regeneration device of the system according to the invention comprises one or more plates 113 for obstructing the flow of the gases, said plates being arranged concentrically between the side walls of the second chamber 105 and the parts of the side walls 108 of the third chamber contained in said second chamber 107. The bottom part of said plate(s) 113 is preferentially arranged at the level of the top of the porous parts of the side walls of the second chamber 105 and of the porous parts of the side walls 108 of the third chamber contained in said second chamber 107.

In one embodiment, the lower wall of the second chamber 111 of the regeneration device of the system according to the invention has the shape of a cone pointing toward the bottom of the device. In this embodiment, the lower part of the second chamber 111 can be inclined by an angle of between 2° and 25°, preferably between 10° and 20°, with respect to the horizontal axis of the collar 106.

In one embodiment, the device of the system according to the invention comprises several openings for departure of the regenerated catalyst 10. They can be positioned centrally and/or peripherally in the lower part of the first chamber 100. This alternative form can be employed when the regeneration device is large in size.

### EXAMPLE

An ebullating bed hydroconversion process which treats a feedstock consisting of a mixture of atmospheric residues and vacuum residues, characterized by a density at 15° C. of 0.995 kg/m³, is considered. The feedstock flow rate in the unit is 11 650 BPD (barrels per day).

It is a unit equipped with just one hydroconversion reactor, the catalyst inventory of which is approximately 140 t.

The treated feedstock has a content of metals (Ni+V) of 55 ppm. It is desired to control the content of metals on the catalyst in the vicinity of 15%, while keeping the mean residence time of the catalyst between 20 and 40 days in order to limit the content of coke deposited on the catalyst, which generally varies between 10% and 50% according to the operating conditions. Under these conditions, the refiner adopts a replacement rate for the fresh catalyst of 0.35 kg/t of feedstock, which corresponds to an addition of fresh catalyst of 0.70 t/d. This then makes it possible for the refiner to control the content of metals deposited on the catalyst in the vicinity of the value of 15.3%. However, with this replacement rate, the mean residence time of the catalyst in the unit corresponding to the renewal time of the inventory is close to 200 d, a very high value, related to the fact that the content of metals of the feedstock, in the region of 55 ppm, is low compared with the contents of metals usually treated in this type of process.

In order to limit the content of coke on the catalyst, it is decided to install a regeneration of the catalyst by withdrawing the catalyst from the reactor in order to send it to a regeneration device according to the invention where the coke is incinerated.

The objective is to lower the content of coke on the catalyst by 15%, with respect to the initial content. To achieve this objective, it is necessary to withdraw approximately 8 times the amount of fresh catalyst added to the unit. Thus, the level of content of coke on the catalyst present in the hydroconversion reactor will be substantially constant in order for the reaction to be able to be carried out with the optimum conversion yields. The regenerated catalyst devoid of the majority of the coke deposited during the hydroconversion recovers most of its catalytic activity making it possible to desulfurize and to demetallize the hydroconverted hydrocarbons. The reintroduction of the regenerated catalyst thus makes it possible to reinforce the catalytic activity of the reaction zone.

The cycles of addition and of withdrawal are thus modified as follows. The initial management, consisting in adding daily of the order of 0.70 t of fresh catalyst every day and in withdrawing the same volume of catalyst from the reactor, is replaced by the following cyclical procedure: on the first day, 6.3 t of fresh catalyst (9 times 0.7 t) are added and the same equivalent volume V is withdrawn, which is sent for reprocessing outside the unit. On the following 8 days, the same volume V of catalyst is withdrawn, which is sent to regeneration in order to incinerate the coke, and one and the same volume V of catalyst which has already undergone regeneration is introduced into the reactor.

It should be emphasized that the density of the withdrawn catalyst is different from the density of the fresh catalyst, in view of the deposits of material on the catalyst in the reactor. In the present case, it was observed that the bulk density of the catalyst exiting the reactor is higher than the density of the fresh catalyst, hence the volume management of the withdrawals of catalyst in order to make it possible to maintain an unvarying inventory.

This procedure makes it possible to remove a part of the coke formed, and to also reduce the mean residence time of the fresh and regenerated catalyst to a value in the vicinity of 22 days. It is then observed that the mean content of coke deposited on the catalyst withdrawn from the reactor is 0.85 times the content of coke which would be observed when the regeneration does not operate, only 6.3 t of fresh catalyst being added once every nine days.

The catalyst which is withdrawn to be regenerated is stored in intermediate holding tanks to be subsequently charged to the regeneration reactor sequentially. As the time necessary to carry out a regeneration cycle on a batch is in the vicinity of 4 days, the regeneration is proportioned to make it possible to regenerate 5 times the volume V withdrawn daily, corresponding to a weight of catalyst of approximately 50 t.

The regeneration is carried out in the regeneration device according to the invention. After transportation, charging and drying, the catalyst is regenerated by a gas stream consisting of a stream of air and of recycled flue gases. In order to limit combustion, the content of O₂ in the incoming gas stream is kept below 1%. Under these conditions, the temperature gradient remains less than 35° C. between the inlet and outlet of the bed. In order to obtain these conditions, the flow rate of recycled flue gases corresponds to 69 times the flow rate of fresh air and the flow rate of gas feeding the reactor during the regeneration is approximately 203 t/h, this flow rate including the flow rate of recycled flue gases. Under these conditions, the combustion phase of the regeneration lasts approximately 48 h and is carried out while gradually increasing the inlet temperature of the gases from 275° C. to 450° C. without ever exceeding the temperature difference of 35° C. of the gases between the inlet and the outlet. The remainder of the time of the regeneration cycle, i.e. 48 h, corresponds to the time required to carry out the other operations of transportation, charging, drying, purging and discharging.

The radial reactor making it possible to carry out the regeneration has the following characteristics. The granular bed is arranged around the central conduit 109 of 1300 mm in diameter. The radial reactor has an internal diameter of 3281 mm and the thickness of the bed of catalyst grains is 863 mm between the porous walls 105 and 108. The height of the bed of catalyst grains traversed radially by the gas is 7.42 m. An additional height of 1.2 m of catalyst is maintained above the catalyst bed traversed radially by the gas (above the top of the openings of the porous walls 105 and 108). A space making it possible to absorb an expansion in volume of the bed of 25% is provided above the granular bed in the radial space.

In order to carry out the fluidization of the bed of catalyst grains during the charging and the discharging, a gas oil stream is introduced at 50° C. Under these conditions, as the minimum fluidization velocity of the catalyst is 0.62 cm/s, a superficial velocity of 1.25 cm/s is applied in the annular space, which makes it possible to limit the expansion of the bed to the vicinity of 10%. The flow rate of gas oil introduced through the opening 101 and necessary to ensure the proper fluidization of the catalyst is thus 264 m³/h during the charging and the discharging.

1. A process for the in situ regeneration of a spent hydroconversion catalyst comprising the following stages:
a) transfer of the spent hydroconversion catalyst between a reaction section (40) comprising a hydroconversion reactor operating as an ebullating bed or as a moving bed, preferably operating as an ebullating bed, and a regeneration section comprising a regeneration device (100);
b) charging of the regeneration device (100) with the spent hydroconversion catalyst;
c) regeneration of the spent hydroconversion catalyst within the regeneration device (100) and the obtaining of a regenerated hydroconversion catalyst;
d) discharging of the regenerated hydroconversion catalyst from the regeneration device (100);
e) transfer of the regenerated hydroconversion catalyst between the regeneration section and the reaction section (40);
said reaction section (40) and said regeneration section being connected to each other by at least one fluidic connection making possible the transfers of the spent hydroconversion catalyst and of the regenerated hydroconversion catalyst.

2. The regeneration process as claimed in claim 1, in which the regeneration section comprises a charging pot (70) containing the spent hydroconversion catalyst awaiting regeneration, and the stage of charging the regeneration device (100) with the spent hydroconversion catalyst comprises a stage of transfer of said spent hydroconversion catalyst between said charging pot (70) and said regeneration device (100).

3. The regeneration process as claimed in claim 1, in which the stage of charging the regeneration device (100) with the spent hydroconversion catalyst is carried out as a fluidized bed with a fluidization liquid.

4. The regeneration process as claimed in claim 3, additionally comprising a stage of draining the fluidization liquid and a stage of drying the spent hydroconversion catalyst prior to the stage of regeneration of said spent hydroconversion catalyst.

5. The regeneration process as claimed in claim 1, in which the regeneration comprises a stage of combustion of the coke and of the sulfur compounds of the spent hydroconversion catalyst, carried out with a gas stream comprising oxygen passing radially through said spent hydroconversion catalyst within the regeneration device (100).

6. The regeneration process as claimed in claim 1, in which the regeneration section additionally comprises a storage chamber (80) for the regenerated hydroconversion catalyst and the stage of discharging the regenerated hydroconversion catalyst from the regeneration device (100) comprises a stage of transfer of said regenerated hydroconversion catalyst between said regeneration device (100) and said storage chamber (80).

7. A hydroconversion process comprising the following stages:
I. a stage of hydroconversion of a hydrocarbon feedstock having an initial boiling point of at least 300° C. carried out in a reaction section (40) comprising a reactor operating as an ebullating bed or as a moving bed in the presence of a hydroconversion catalyst and of hydrogen;
II. a stage of withdrawal of spent hydroconversion catalyst and of additional contribution of fresh hydroconversion catalyst originating from a storage chamber (20) for the fresh catalyst and of hydroconversion catalyst regenerated according to the regeneration process as claimed in claim 1 within said reaction section (40).

8. The hydroconversion process as claimed in claim 7, in which the stages of withdrawal of spent hydroconversion catalyst and of additional contribution of fresh hydroconversion catalyst and of regenerated hydroconversion catalyst are carried out by conveying in the liquid phase.

9. The hydroconversion process as claimed in claim 7, in which the stages of withdrawal of spent hydroconversion catalyst and of additional contribution of fresh hydroconversion catalyst and/or of regenerated hydroconversion catalyst are carried out by a single device which can be pressurized and depressurized (30).

10. A system comprising:
a reaction section (40) comprising a hydroconversion reactor operating as an ebullating bed or as a moving bed;
a regeneration section comprising a regeneration device (100);
means for the transfer of hydroconversion catalyst between said reaction section (40) and said regeneration section comprising at least one fluidic connection;
means for charging said regeneration device (100) as a fluidized bed or as a moving bed.

11. The system as claimed in claim 10, in which the regeneration device comprises:
a first chamber (100) arranged around a vertical axis comprising, in its upper part, an opening for admission of regeneration gas (14) and an opening for entry of the spent catalyst (9), said first chamber (100) comprising, in its lower part, an opening for departure of the regeneration gases (15) and an opening for departure of the regenerated catalyst (10);
a second chamber (107), concentric with the first chamber (100) and arranged inside the latter so as to form a space between said first chamber (100) and said second chamber (107), said second chamber being capable of containing a bed of grains of spent catalyst to be regenerated and comprising a leaktight upper wall (114), side walls (105) which are porous over at least a part of their height, the porosity of said side walls (105) being suitable for making possible the flow of the regeneration gases, and a lower wall (111), said second chamber (107) being in fluidic connection with the opening for entry of the spent catalyst (9) and the opening for departure of the regenerated catalyst (10);
a third chamber forming a central conduit (109) concentric with the second chamber (107) passing through said second chamber (107) and the first chamber (100), said third chamber (109) being porous over all of the parts of its side walls (108) contained in said second chamber (107) for the evacuation of the regeneration gases, said third chamber (109) being in fluidic connection with the opening for departure of the regeneration gases (15).

12. The system as claimed in claim 11, in which the regeneration device comprises a partition (106) arranged in the space between the first chamber (100) and the second chamber (107) supporting the side walls (105) of said second chamber (107) and separating in a leaktight manner said space between the first chamber (100) and the second chamber (107) into a first empty upper zone (103, 104) and a second empty lower zone (112), and the first chamber (100) comprises, in its lower part, an opening (101) for the introduction and the departure of a fluidization liquid in said second empty lower zone (112) and the lower wall (111) of the second chamber (107) is porous in order to make possible the flow of said fluidization liquid into said second chamber (107).

13. The system as claimed in claim 12, in which the upper part of the first chamber (100) of the regeneration device comprises an opening (102) for the evacuation of the excess fluidization liquid, said opening (102) being in fluidic connection with the second chamber (107).

14. The system as claimed in claim 11, in which the regeneration device comprises a deflector (110) installed in the second chamber (107) above the third chamber (109) and below the opening for entry of the spent catalyst (9).

15. The system as claimed in claim 11, in which the regeneration device comprises one or more plates (113) for obstructing the flow of the gases, said plates being arranged concentrically between the side walls of the second chamber (105) and the parts of the side walls (108) of the third chamber contained in said second chamber (107).
